(19) United States
(12) Patent Application Publication
(10) Pub. No.: US 2007/0138686 A1
(43) Pub. Date: Jun. 21, 2007

(54) MELT-SPINNING DEVICE AND PROCESS FOR THREADING SEVERAL MULTIFILAMENT YARNS IN A MELT-SPINNING DEVICE

(75) Inventors: Tilman Reutter, Eidenberg (AT); Diethard Hubner, Bordesholm (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Saurer GmbH & Co. KG

(21) Appl. No.: 11/618,044

(22) Filed: Dec. 29, 2006

Related U.S. Application Data
(63) Continuation of application No. PCT/EP05/06841, filed on Jun. 24, 2005.

(30) Foreign Application Priority Data
Jun. 29, 2004 (DE) 10 2004 031 252.4

(51) Int. Cl. D01D 5/08; B29C 47/00

(52) U.S. Cl. 264/103; 264/211.12; 425/378.2; 425/382.2; 425/72.2

(57) ABSTRACT

A melt spinning device used for producing a plurality of multifilament yarns and which comprises a plurality of spinning nozzles for extruding a plurality of filament bundles, a preparation device for separately combining the filament bundles to individual yarns and a plurality of treatment devices. The filament bundles, when being extruded, are separated by a center distance (M) and the yarns in the treatment device are guided in a substantially smaller treatment spacing (B). This provides an especially compact melt spinning device and allows a rapid and uncomplicated threading of the filament bundles. For this purpose, a plurality of separating yarn guides are mounted downstream of the preparation device in the thread path. The separating yarn guides are arranged at a yarn spacing (S) to each other which is substantially smaller than the center distance (M). The filament bundles can thus be immediately separated by the movement of a manually guided suction device which withdraws the filament bundles directly from the spinning nozzles during thread-up.

### CROSS REFERENCE TO RELATED APPLICATION

The present application is a continuation of international application PCT/EP2005/006841, filed 24 Jun., 2005, and which designates the U.S. The disclosure of the referenced application is incorporated herein by reference.

### BACKGROUND OF THE INVENTION

The present invention relates to a melt-spinning device for the production of multiple multifilament yarns, as well as to a process for threading multiple multifilament yarns in such a device.

In the production of melt-spun multiple multifilament endless yarns a plurality of strand-like filaments are first extruded from several spinnerets. For this, each of the spinnerets comprises a plurality of spinning orifices so that the filament strands extruded from a spinneret form a filament bundle. After cooling of the filament strands, each of the filament bundles is combined separately to form a yarn so that in the spinning line a so-called convergence point is formed. This convergence point, which defines the combining of the individual filament strands, is assigned to the spinnerets so that a yarn spacing is established which is essentially equal to a center spacing of two neighboring spinnerets. A spinning device of this type is, for example, known from DE 199 29 817 A1 and corresponding U.S. Pat. No. 6,814,828.

In the known spinning device the filament bundles are combined at the convergence point by a preparation device to form individual yarns. Subsequently, the yarns are guided next to one another and with a small yarn spacing into the treatment device disposed downstream and treated.

For the initial thread-up of the yarns, it is customary that after the spinning of the filament bundle by the spinning device the individual filament bundles are taken up together by a manually guided suction device, preferably a suction pistol, and are continuously drawn off from the spinnerets. Subsequently, in sequence, the separation of the filament bundles held together in a suction orifice takes place to form the yarns at the convergence point, and the yarns are guided to establish a treatment spacing. In so doing, the thread-up in particular is a manual operation which costs time while wasting much material. A rapid thread-up of the yarns to avoid greater amounts of waste is thus desirable.

In order to obtain the same physical properties in each of the yarns it is furthermore a known practice in the known spinning devices not to exceed certain angles of traverse for combining the yarns at the treatment spacing. Thus, significant heights of the melt-spinning device cannot be avoided where a plurality of yarns are spun in parallel, which in turn makes the thread-up procedure of the yarns for separating and combining more difficult.

It is thus the object of the invention to develop a melt-spinning device of the generic type with yarn guiding which makes possible a low overall height of the melt-spinning device, as well as a rapid initial thread-up of the yarns.

It is an additional objective of the invention to provide a process for the thread-up of multifilament yarns in such an apparatus, where in said process a high degree of automation can be achieved.

### SUMMARY OF THE INVENTION

The invention is based on the insight that the filament bundles are extruded from individual spinnerets which are at a distance from one another. In spinning and thread-up of the filament bundles, the bundles are taken up in common by a suction device so that all the filament strands of the filament bundles are combined in a suction orifice of the suction device. In so doing, each of the filament bundles forms a straight line between the suction device and the respective spinneret. Based on the center spacing between the spinnerets, said spacing in technical circles also being called a nozzle spacing, these straight lines run at an angle to one another to the opening of the suction device. Thus, the convergence points of the filament bundles can be defined independently of the center spacing of the spinnerets.

The melt-spinning device according to the invention comprises an auxiliary spreading means which includes several separating yarn guides in the yarn path downstream from a preparation device. The separating yarn guides have a yarn spacing which is significantly less than the center spacing between the spinnerets. Thus, the, in particular outer, filament bundles are guided in the melt-spinning device with traversing in such a manner that the spacing between the filament bundles is constantly reduced up to separation. In so doing, the yarn spacing in the separation of the filament bundles is chosen in such a manner that, on the one hand, no interaction of the filament bundles occurs and, on the other hand, a permissible maximum traverse of the filament strands is not exceeded.

Due to the reduced yarn spacing in the separation of the filament bundles, the filament bundles can advantageously be guided during thread-up directly by the suction device. In a manually guided suction device in the form of a suction pistol the separation process can be carried out by simple handling by one operator. An additional manual operating step by isolating the filament bundles, due to yarn spacings which are too great, can be omitted.

In order to make possible thread-up of the filament bundles even before the separation in the upstream preparation device, an extension of the invention is particularly advantageous, wherein an auxiliary guide means is assigned to the preparation device, and wherein the auxiliary guide means can be moved to guide the yarns into the preparation device from a traversing position into an operating position.

Particularly advantageous here is the formation of the auxiliary guide means with a sliding edge on which the filament bundles are guided. With this, any yarn spacing arising can be realized independently of the distance of the suction device from the auxiliary guide means.

In order to obtain a threading of the filament bundles into the preparation device by displacement of the auxiliary guide means, the preparation device is advantageously disposed in the yarn path upstream from the separating yarn guides in such a manner that the filament bundles can be guided between the spinnerets and a preparation device without significant diversion. The filament bundles can thus advantageously be guided from their natural path into the preparation device.

In the case that the preparation device comprises several yarn-oiling members assigned to the yarns, the auxiliary guide means is preferably formed by a diverting rod which comprises a sliding edge which extends parallel to the yarn-oiling members, and is held on a pivot arm. Thus, the filament bundles can be spread on the sliding edge of the diverting rod in a simple manner before the separation. Even with a greater spacing between the preparation device and the auxiliary spreading means, on the diverting rod of the auxiliary guide means the yarn spacings, which increase during the guiding of the suction device, can develop without hindrance. By pivoting the diverting rod from the traversing position into the operating position the filament bundles are automatically run into the yarn-oiling members after the separation of the filament bundles.

In order to obtain an intensive moistening of the filament bundles when there is a large number of filament bundles, several yarn-oiling members may be assigned to one yarn, where the yarn-oiling members assigned to one yarn are positioned with their yarn-guiding faces opposite one another. Here, the auxiliary guide means can advantageously be enhanced by a second diverting rod which is assigned to the yarn-guiding means disposed downstream.

In a particularly advantageous extension of the invention the auxiliary guide means comprises, along with the diverting rod, a traversing rod extending parallel to and at a distance from the diverting rod, said traversing rod being pivotable together the diverting rod between a traversing position and an operating position. In the operating position the yarns are held on the yarn-oiling members by the traversing rod.

In order to be able to carry out the separation of the individual filament bundles with as small a yarn spacing as possible and thus in a position relatively near to a divergence point of the suction pistol, an extension of the invention is particularly advantageous in which the separating yarn guides are formed so as to be associated with a guide plate. Here, a guide port in the guide plate is assigned to each of the separating yarn guides, said port opening at a spreading edge of the guide plate. In connection with this, the spacing between the guide ports on the spreading edge is preferably formed to be less than the yarn spacing between the separating yarn guides. For threading the filament bundles into the guide ports the suction device with the suction orifice can be guided at a relatively small distance from the spreading edge.

The spreading of the yarns into a downstream treatment device is particularly advantageous in the case in which an entanglement device is disposed immediately downstream from the separating yarn guides. In this case, the threading into the entanglement device can be done with the aid of the separating yarn guides.

In connection with this, it is advantageous if the entanglement device is disposed upstream from a first guide plate with the separating yarn guides and a second guide plate with several outlet yarn guides is disposed downstream. The guide plates preferably comprise guide ports for guiding in the yarns, said guide ports thus making possible a secure threading into the entanglement device.

In many cases the treatment devices are disposed so as to be turned by 90° relative to the row of spinnerets. In these cases it is thus required that the yarns must be transferred from a spinning plane into a treatment plane. An extension of the invention is particularly advantageous for this. The entanglement device is disposed in the transition between the spinning plane and the treatment plane, where the individual yarn channels of the entanglement device are disposed so as to be offset relative to one another. With this, the yarns, after the threading into the entanglement device, can be guided in a simple manner into a following treatment device, e.g. a stretching or drawing mechanism.

With a large number of yarns spun in parallel, the spreading of yarns can be improved still further by an auxiliary separating device being disposed in the yarn path between the spinneret and the auxiliary spreading means, where the pre-division of the filament bundles during the spreading is done by the auxiliary separating device.

The auxiliary separating device can be formed by separating plates in a drop shaft or preferably by a profiled plate with several notches, where the profiled plate can be pivoted in such a manner that is can be moved into the yarn path between the cooling shaft and a drop shaft.

The process according to the invention for threading several multifilament yarns in a melt-spinning device is distinguished by a simple and rapid handling by an operator. After the filament bundles have been spun and taken up by the suction orifice of a suction device, preferably a suction pistol, the filament bundles can be separated and guided by guiding the suction pistol in a simple manner with the aid of the threading means.

Here, before the separation for guiding into the preparation device, the filament bundles are preferably spread on an auxiliary guide means through which the filament bundles are guided up to separation in a traversing position. For the guiding of the filament bundles into the preparation device the auxiliary guide means is pivoted from the traversing position into an operating position. In so doing, the filaments are automatically guided into the preparation device.

### BRIEF DESCRIPTION OF THE DRAWINGS

In the following, the melt-spinning device according to the invention as well as the process for threading multifilament yarns in the melt-spinning device is explained in more detail, with reference to the accompanying drawings, in which:

FIG. 1 to FIG. 3 schematically illustrate a first exemplary embodiment of the melt-spinning device according to the invention in several views,

FIG. 4 to FIG. 7 schematically illustrate an additional embodiment of the melt-spinning device in several views,

FIG. 8 and FIG. 9 schematically illustrate an additional embodiment of the melt-spinning device according to the invention in several views, and

FIG. 10 schematically illustrates an embodiment of a preparation device with auxiliary guide means for spreading the yarns.

### DETAILED DESCRIPTION OF THE PREFERRED EMBODIMENTS

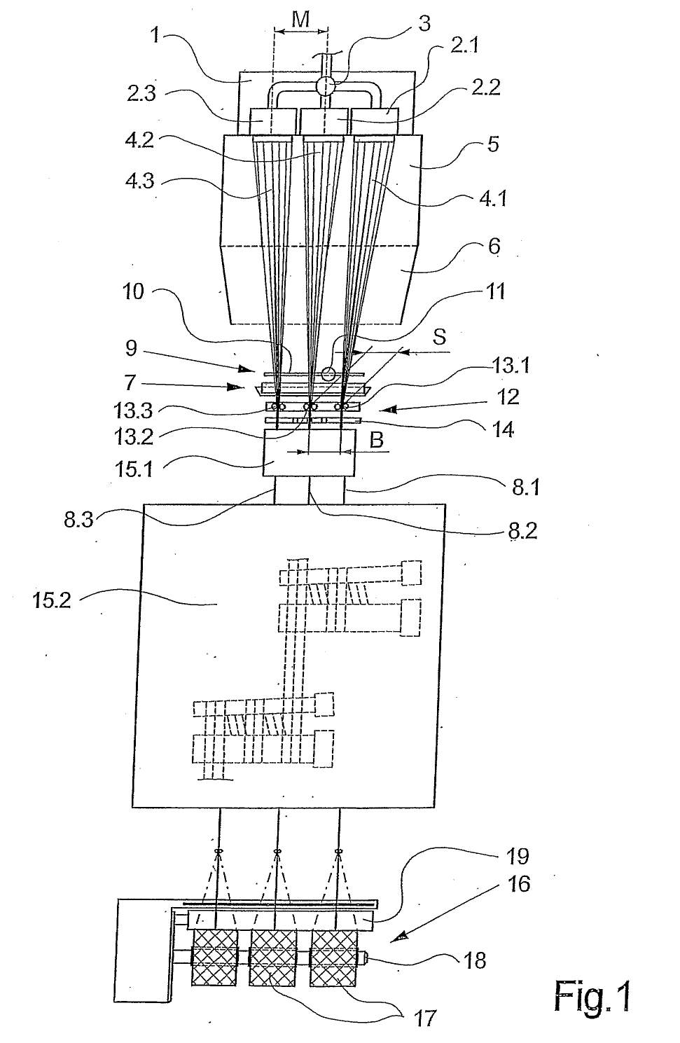

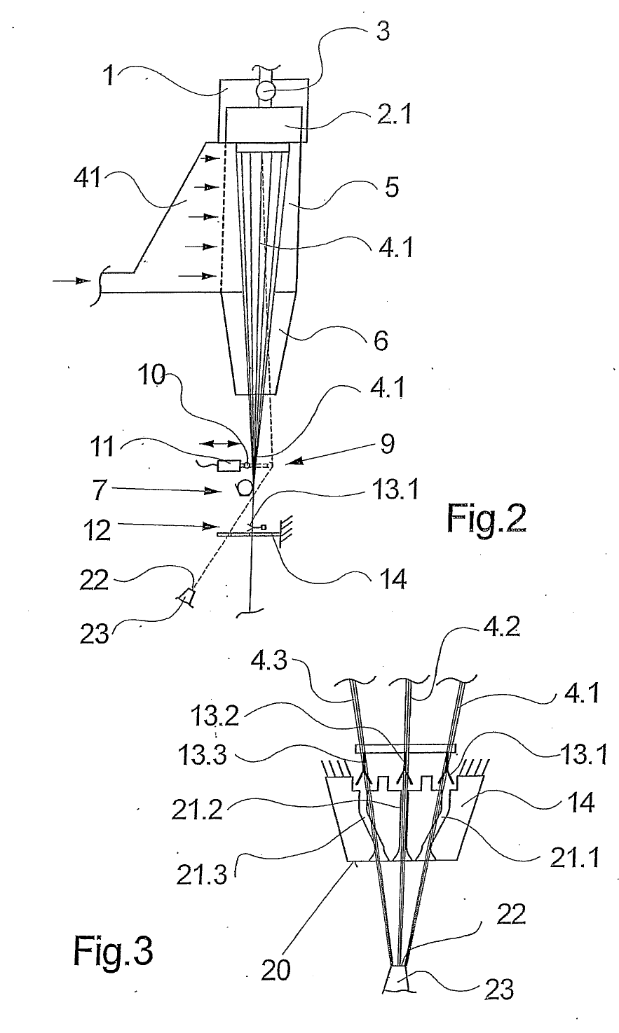

In FIGS. 1 to 3, a first embodiment of a melt-spinning device according to the invention is represented schematically in several views. FIG. 1 shows a complete view of the melt-spinning device in operation, FIG. 2 a partial view of the melt-spinning device in the initial spreading of the yarns, and FIG. 3 a plan view of the spreading aid for FIGS. 1 and 2.

In so far as no express reference to one of the figures is made, the following description applies to all the figures.

The melt-spinning device comprises several spinnerets 2.1, 2.2, and 2.3 which are disposed on an underside of a heatable spinneret housing 1. A melt distributor 3 is assigned to the spinnerets 2.1, 2.2, and 2.3, said melt distributor being connected to a melt generator (not represented here). Downstream from the spinnerets 2.1, 2.2, and 2.3 a cooling shaft 5 and a drop shaft 6 immediately downstream from the cooling shaft 5 are disposed. The cooling shaft 5 is connected to a cooling flow generator 41 (FIG. 2) through which a stream of cool air flowing transverse to the cooling shaft 5 can be produced.

Downstream from the drop shaft 6 a preparation device 7 and several treatment devices 15.1 and 15.2 are disposed. The configuration of the treatment devices 15.1 and 15.2 is dependent on the type of yarn to be produced by the melt-spinning device in each case. Thus, for example, for the production of fully stretched yarns (FDY) the second treatment device 15.2 is formed as a stretching or drawing mechanism with several godet units (indicated by dashed lines) for stretching the yarn. Therein, the first treatment device 15.1 could be formed as an entanglement device in order to obtain improved yarn cohesion by swirling the filament strands.

At its end, the melt-spinning device comprises a winding device 16, through which spools 17 are wound on a spool spindle 18.

In operation, several filament bundles 4.1, 4.2, and 4.3 are extruded in parallel next to one another with the melt-spinning device. For this, a polymeric melt is fed under pressure to the spinnerets 2.1, 2.2, and 2.3. The spinnerets 2.1, 2.2, and 2.3 comprise on their underside a nozzle plate which comprises a plurality of nozzle orifices. Through each of the nozzle orifices a filament strand is extruded. The plurality of filament strands for each of the spinnerets 2.1, 2.2, and 2.3 forms a respective filament bundle. Thus, for example, the filament bundle 4.1 is formed by the extruded filament strands of the spinneret 2.1.

The filament strands of the filament bundles 4.1, 4.2, and 4.3 are drawn off, via draw-off elements, from the spinnerets 2.1, 2.2, and 2.3 into the treatment devices 15.1 and 15.2. In so doing, the filament strands of the filament bundles 4.1, 4.2, and 4.3 run though the cooling shaft 5 and the drop shaft 6, where in the cooling shaft 5 a coolant acts on the filament strands. At the end of the drop shaft 6 the filament bundles 4.1, 4.2, and 4.3 are guided through a preparation device 7 in order to moisten the individual filament strands of the filament bundles 4.1, 4.2, and 4.3. In so doing, cohesion of the filament strands of the filament bundles 4.1, 4.2, and 4.3 develops so that a respective multifilament yarn 8.1, 8.2, and 8.3 is formed. Thus, downstream from the preparation device 7, each of the filament bundles 4.1, 4.2, and 4.3 is fed as a yarn 8.1, 8.2, and 8.3 to the subsequent treatment devices 15.1 and 15.2. At the end of the treatment the yarns 8.1, 8.2, and 8.3 are each wound onto a spool 17 in the winding device 16. For this, the winding device 16 comprises a changing device (not represented) as well as a compression roller 19 which abuts the circumferential surface of the spools 17, in order to lay the yarns 8.1, 8.2, and 8.3 onto the spools 17.

Before the spinning process of the previously described type can be carried out, the yarns must be laid into the devices of the melt-spinning device. In order for it to be possible for an operator to perform the initial threading of the yarns in as rapid and simple a manner as possible, the melt-spinning device comprises aids which are described below in more detail. In the yarn path an auxiliary guide means 9 is assigned to the preparation device 7. The auxiliary guide means 9 is formed in this embodiment by a guide rod 10 which extends parallel to a yarn path plane in which the filament bundles 4.1, 4.2, and 4.3 are guided. On the guide rod 10 an actuator 11 acts, through which the guide rods 10 can be displaced between a traversing position and an operating position.

In the yarn path, an auxiliary spreading means 12 is disposed downstream from the preparation device 7. The spreading means 12 comprises several separating yarn guides 13.1, 13.2, and 13.3. The separating yarn guides 13.1, 13.2, and 13.3 are disposed in the yarn path plane, next to one another, and with spacing. Here, the yarn spacing between the several separating yarn guides 13.1, 13.2, and 13.3 is significantly less than the spacing of the filament bundles 4.1, 4.2, and 4.3 during the extrusion through the spinnerets 2.1, 2.2, and 2.3. The spacing of the filament bundles 4.1, 4.2, and 4.3 during the extrusion is the same as the center spacing M between the spinnerets 2.1, 2.2, and 2.3. Here, the center spacing M denotes the distance between the central axes of the spinnerets. The center spacing is also denoted as the nozzle spacing. The center spacing of the filament bundles 4.1, 4.2, and 4.3 is significantly greater than the spacing between the yarns during the treatment. Here, the spacing between the yarns 8.1, 8.2, and 8.3 during the treatment is donated as the treatment spacing B. The treatment spacing B preferably lies in a range from 8 mm to 30 mm.

In the embodiment represented in FIG. 1 the yarn spacing between the separating yarn guides, which here is denoted by the letters S, is formed so as to be essentially equal to the treatment spacing B. In principle, however, it could be made somewhat greater than or less than the treatment spacing.

A guide plate 14 is assigned to the separating yarn guides 13.1, 13.2, and 13.3. The joint action of the separating yarn guides 13.1, 13.2, and 13.3 is explained with the guide plate 14 below with reference to FIG. 3.

The guide plate 14 assigned to the separating yarn guides 13.1, 13.2, and 13.3 comprises one guide port 21.1, 21.2, and 21.3 for each of the separating yarn guides 13.1, 13.2, and 13.3. One end of the guide ports 21.1, 21.2, and 21.3 opens immediately at the level immediately above the separating yarn guides 13.1, 13.2, and 13.3. An opposite end of the guide ports 21.1, 21.2, and 21.3 empties at a spreading edge 20 which is disposed at a distance from the separating yarn guides 13.1, 13.2, and 13.3. Along with this, the mouth ends of the guide ports 21.1, 21.2, and 21.3 at the spreading edge 20 have a yarn spacing which is preferably formed to be less than the yarn spacing of the separating yarn guides 13.1, 13.2, and 13.3.

For the initial threading of the filament bundles 4.1, 4.2, and 4.3 after the spinning through the spinnerets 2.1, 2.2, and 2.3, they are first picked up together by the suction device 23. The suction device 23, which is preferably formed by a manually guided suction pistol, comprises a suction orifice 22, as is represented in FIGS. 2 and 3. The filament bundles 4.1, 4.2, and 4.3 are led away together in the suction orifice 22 and continuously drawn off from the spinnerets 2.1, 2.2, and 2.3. To thread the filament bundles 4.1, 4.2, and 4.3, the suction device 23 is first guided around the guide rod 10 of the auxiliary guide means 9. Here, the guide rod 10 of the auxiliary guide means is in the traversing position. This situation is represented in dashed lines in FIG. 2. The filament bundles 4.1, 4.2, and 4.3 are guided on a sliding edge of the guide rod 10 at a distance from the preparation device 7.

In order to separate the filament bundles 4.1, 4.2, and 4.3 from one another, the suction device 23 is guided at a short distance below the guide plate 14 in the direction of the spreading edge 20. Since, as before, the filament bundles 4.1, 4.2, and 4.3 are drawn off from the spinnerets 2.1, 2.2, and 2.3 immediately by the suction device 23, the spacing between the filament bundles increases with increasing distance from the suction orifice 22. By moving the suction device 23 towards the spreading edge 20, the division of the filament bundles 4.1, 4.2, and 4.3 can be done in such a manner that each of the filament bundles 4.1, 4.2, and 4.3 falls into one of the guide ports 21.1, 21.2, and 21.3 and with further movement of the suction device 23 are automatically threaded into the separating yarn guides 13.1, 13.2, and 13.3. Then the filament bundles 4.1, 4.2, and 4.3 are separated from one another so that the yarns 8.1, 8.2, and 8.3 can be laid by the suction device 23 manually in a simple manner into the following devices. The separating yarn guides 13.1, 13.2, and 13.3 thus represent a convergence point in which the filament strands of each of the filament bundles 4.1, 4.2, and 4.3 are guided together to form a yarn. Immediately after the separation of the filament bundles 4.1, 4.2, and 4.3 the auxiliary guide means 9 is pivoted into an operating position so that the filament bundles 4.1, 4.2, and 4.3 are automatically guided into the guide rod 10. For this, the actuator 11 is activated so that the guide rod 10 is guided from the traversing position into the operating position. This situation is represented in FIG. 2.

The preparation device 7 is represented in this embodiment as a roller preparation in which the filament bundles 4.1, 4.2, and 4.3 are guided on a moistened roller surface. In connection with this, the spacing between the filament bundles 4.1, 4.2, and 4.3 in the preparation device is dependent on the center spacing M of the filament bundles 4.1, 4.2, and 4.3 during the extrusion and on the yarn spacing S of the separating yarn guides 13.1, 13.2, and 13.3. The preparation device 7 is located in the zone of the spreading of the filament bundles 4.1, 4.2, and 4.3 so that the means for preparing the filament bundles 4.1, 4.2, and 4.3 is formed in such a manner that each of the filament bundles 4.1, 4.2, and 4.3 can be prepared in its natural yarn path.

In an embodiment of the melt-spinning device according to the invention and represented in FIG. 1, the separating yarn guides 13.1, 13.2, and 13.3 can be used at the same time as a collecting yarn guide which immediately enables the guiding of the yarns into the following treatment device 15.1. For this, the yarn spacing S of the separating yarn guides 13.1, 13.2, and 13.3 is made to be equal to the treatment spacing B.

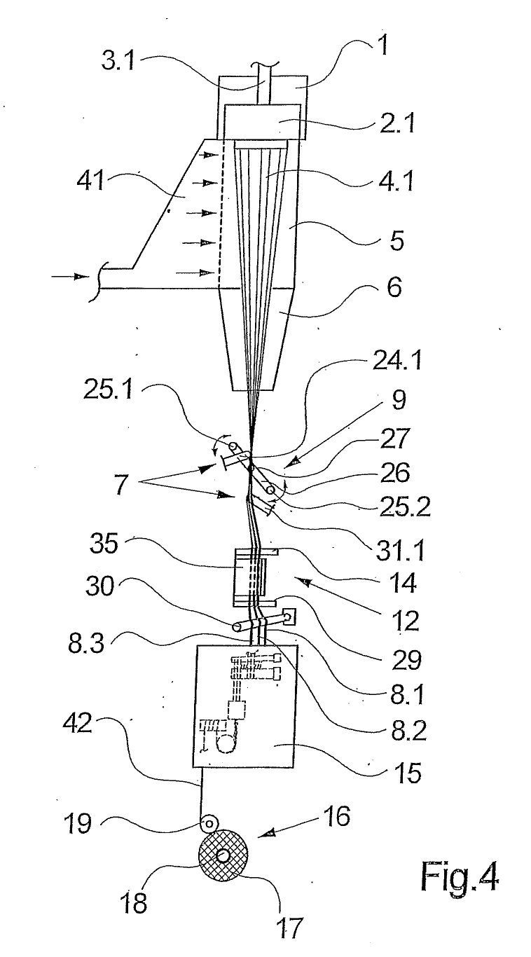

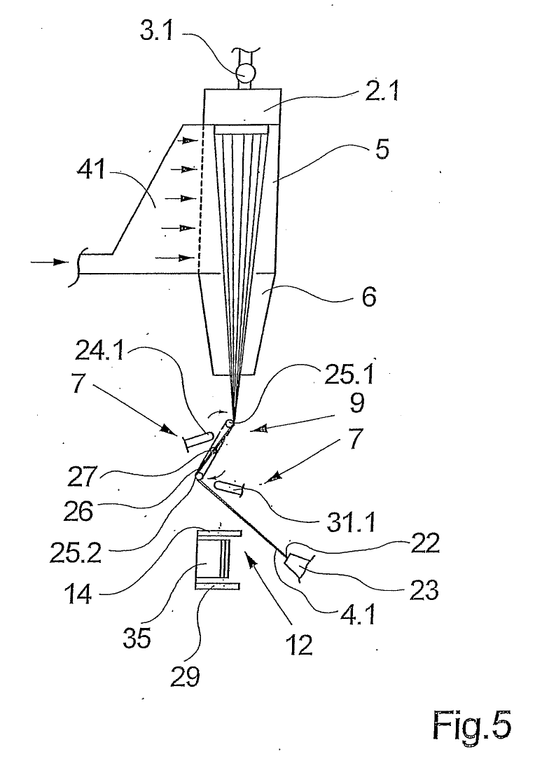

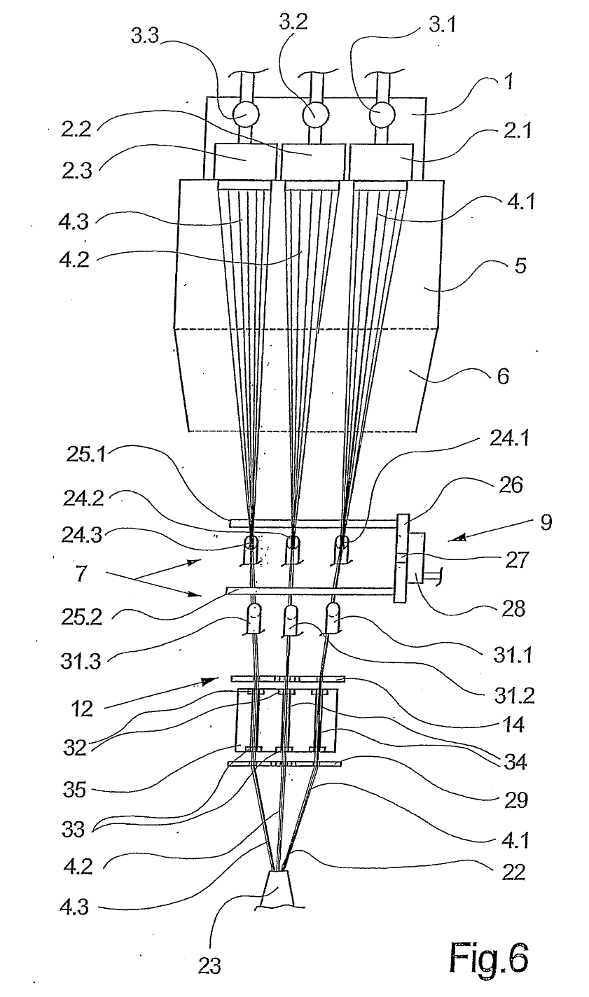

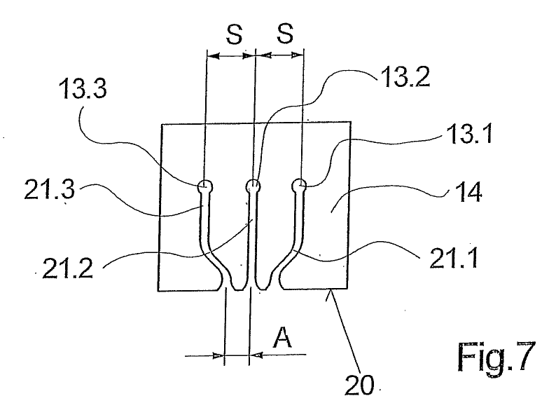

In FIGS. 4 to 7 an additional embodiment of a melt-spinning device according to the invention is represented in several view and situations. FIG. 4 shows a view of the embodiment in operation. FIGS. 5 and 6 show several views of the embodiment during the thread-up process at the beginning of the process and FIG. 7 shows a plan view of the auxiliary spreading means in the melt-spinning device from FIG. 4. In so far as no express reference to one of the figures is made, the following description applies to all the figures.

The embodiment represented in FIG. 4 is essentially identical to the embodiment according to FIG. 1. Thus only the differences will be explained in the following.

The embodiment according to FIG. 4 represents the melt-spinning device by which a multicolor yarn is produced. For this, each of the spinnerets 2.1, 2.2, and 2.3 is connected via separate melt distributors 3.1, 3.2, and 3.3 to one of several melt sources so that in each of the spinnerets 2.1, 2.2, and 2.3 differently colored filament bundles 4.1 to 4.3 can be extruded. After cooling and preparation the filament bundles 4.1, 4.2, and 4.3 are guided together to form the yarns 8.1, 8.2, and 8.3 and are guided into a treatment device 15. In the treatment device 15 the yarns 8.1, 8.2, and 8.3 are textured, guided together to form a composite yarn 42, and guided onto a winding device 16. To that extent this embodiment is distinguished essentially by the fact that in the treatment device the yarns 8.1, 8.2, and 8.3 formed from the filament bundles 4.1, 4.2, and 4.3 are guided together in the treatment device 15 to form a composite yarn 42 and are wound onto a spool. As treatment devices a stretching mechanism, a crimping device, a cooling device, and a draw-off device could be provided, as indicated in FIG. 4 with dashed lines.

As an additional difference, the filament bundles 4.1, 4.2, and 4.3 are guided in a spinning plane to form the yarns 8.1, 8.2, and 8.3. The treatment of the yarns 8.1, 8.2, and 8.3 is, however, done in a treatment plane offset by 90° so that between the treatment device 15 and the preparation device 7 there is a turning of the yarn bundle from a spinning plane into a treatment plane. For this, an entanglement device 35 and a yarn guide rod 30 are disposed between preparation device 7 and the treatment device 15. The entanglement device 35 comprises one treatment channel 34 per yarn (FIG. 6) in which a swirling of the yarn takes place. Therein the treatment channels are disposed so as to be offset to one another relative to the spinning plane so that the yarns 8.1 to 8.3 are guided out of the spinning plane during the transition from the preparation device 7 into the entanglement device 35. After running out of the entanglement device 35 the additional turning of the yarn bundle is done via one or more yarn guide rods 30. On leaving the yarn guide rod 30 the yarns 8.1, 8.2, and 8.3 are turned further in the direction of the treatment plane so that the yarns in the treatment device 15 can be guided in the treatment plane.

To prepare the filament bundles 4.1, 4.2, and 4.3 drawn off in the spinnerets 2.1 to 2.3, the preparation device 7 comprises several yarn-oiling members 24.1, 24.2, and 24.3 assigned to the filament bundles 4.1, 4.2, and 4.3. Counter yarn-oiling members 31.1 to 31.3 are disposed downstream from each of the yarn-oiling members 24.1 to 24.3 in the yarn path so that the yarn-oiling members 24.1 to 24.3 and the counter yarn-oiling members 31.1 to 31.3 are positioned with their yarn contact faces opposite one another. Thus the filament bundles 4.1 to 4.3 are prepared from two sides.

For the initial thread-up of the filament bundles 4.1 to 4.3 an auxiliary guide means 9 is assigned to the preparation device 7. The auxiliary guide means 9 is formed by a first diverting rod 25.1 and a second diverting rod 25.2. The first diverting rod 25.1 is assigned to the yarn-oiling members 24.1 to 24.3, where the diverting rod 25.1 extends in parallel to the yarn-oiling members 24.1 to 24.3 disposed in a plane. The second diverting rod 25.2 is assigned to the counter yarn-oiling members 31.1 to 31.3. The diverting rods 25.1 and 25.2 are held on a pivot arm 26 in such a manner that they project out. The pivot arm 26 is mounted in such a manner that it can turn on a pivot axle 27. This turning of the pivot arm 26 can be effected by an actuator 28. Through the movement of the pivot arm 26 the diverting rods 25.1 and 25.2 can be displaced between a traversing position and an operating position.

In FIG. 4 the situation is represented in which the diverting rods 25.1 and 25.2 are held in an operating position. Here, the diverting rods 25.1 and 25.2 are pivoted out from the yarn path so that the filament bundles 4.1 to 4.3 are guided into the yarn-oiling members 24.1 to 24.3 and the counter yarn-oiling members 31.1 to 31.3.

In FIG. 5 the diverting rods 25.1 and 25.2 are shown in the traversing position, in which the filament bundles 4.1 to 4.3 are guided in contact with the diverting rods 25.1 and 25.2. This situation represents the thread-up process of the filament bundles 4.1 to 4.3 of the melt-spinning device. The filament bundles 4.1 to 4.3 are taken up via the suction device 23 and continuously drawn off from the spinnerets 2.1 to 2.3. As follows from FIGS. 5 and 6, an auxiliary spreading member 12 is disposed in the yarn path downstream from the preparation device 7. The auxiliary spreading member 12 is formed in this embodiment by a guide plate 14.

The guide plate 14 is represented in FIG. 7 in a plan view. In the guide plate 14 three separating yarn guides 13.1, 13.2, and 13.3 are introduced. The yarn spacing S between the separating yarn guides 13.1, 13.2, and 13.3 is formed so as to be significantly less than the center spacing M between the spinnerets 2.1, 2.2, and 2.3. A guide port 21.1 to 21.3 in the guide plate 14 is assigned to each of the separating yarn guides 13.1, 13.2, and 13.3 which empty at the spreading edge 20. The mouths of the guide ports 21.1 to 21.3 at the spreading edge 20 each have a yarn spacing A which is less than the yarn spacing S of the separating yarn guides. Thus, the filament bundles 4.1 to 4.3 guided manually in the suction device 23 can be separated and threaded in with a slight spacing of the suction orifice 22 from the guide plate 14.

In FIG. 5 the situation is represented immediately before separation. Here, the filament bundles 4.1 to 4.3 are guided by the suction device 23 and drawn off from the spinnerets 2.1 to 2.3. In so doing, before the separation, the filament bundles 4.1 to 4.3 are spread on the auxiliary guide means 9, due to which a later automatic guiding in of the filament bundles into the preparation device 7 is possible. The auxiliary guide means 9 guides the filament bundles 4.1 to 4.3 on the diverting rods 25.1 and 25.2, in each case in a traversing position. The diverting rods 25.1 and 25.2 each comprise a sliding edge so that with additional guiding of the suction device 23 the yarn spacings between the filament bundles 4.1 to 4.3 can be adapted automatically to the natural yarn path. To separate the filament bundles 4.1 to 4.3 the suction device 23 is guided immediately below the guide plate 14 with the filament bundles 4.1 to 4.3 to the spreading edge 20. The filament bundles 4.1 to 4.3 guided spread from the suction opening orifice up to the spinnerets 2.1 and 2.3 are then threaded into the guide ports 21.1 to 21.3 and with further guiding of the suction device 23 automatically conducted into the separating yarn guides 13.1 to 13.3.

For additional explanation of the spreading process reference is made to FIG. 6. The entanglement device 35 is disposed in the yarn path immediately downstream from the auxiliary spreading means 12. The entanglement device 35 comprises for each yarn an inlet yarn guide 32, a treatment channel 34, and an outlet yarn guide 33. In order to be able to thread the filament bundles 4.1 to 4.3 into the entanglement device 35, a guide plate 29 is disposed in the yarn path downstream from the entanglement device 35. The guide plate 29 is formed so as to be essentially identical to the guide plate 14. Here, the guide ports introduced in the guide plates 14 and 29 are formed in such a manner that with the inlet yarn guides 32, the treatment channels 34, and the outlet yarn guides 33, they each span a threading plane. Thus, along with the separation, an automatic threading of the filament bundles 4.1 to 4.3 into the entanglement device 35 can be achieved by threading in of the filament bundles 4.1 to 4.3 on the lower guide plate 29.

In FIG. 6 the situation after the thread-up is represented. The filament bundles are, as before, drawn off from the spinnerets 2.1 to 2.3 by the suction device 23. Here, the filament bundles 4.1 to 4.3 are guided on the diverting rods 25.1 and 25.2 as well as the guide plates 14 and 29. By activation of the turning actuator 28 the diverting rods 25.1 and 25.2 are each pivoted from their traversing positions into their operating positions so that the filament bundles 4.1 to 4.3 automatically fall into their assigned yarn-oiling members 24.1 to 24.3 and counter yarn-oiling means 31.1 to 31.3. By guiding the filament bundles 4.1 to 4.3 on the diverting rods 25.1 and 25.2, the yarn spacing between the filament bundles which arises due to the natural yarn path can be maintained so that through the pivoting of the diverting rods 25.1 and 25.2 a reliable threading into the preparation device 7 is possible.

In the embodiment represented in FIG. 4, the separating yarn guides in the auxiliary spreading means 12 are formed in such a manner that yarn guiding occurs only for the purposes of spreading and separating. During operation the yarns 8.1, 8.2, and 8.3 are guided by the inlet yarn guides 32 of the entanglement device 35.

The embodiment according to FIGS. 1 and 2 is distinguished in particular by the fact that the separation of the filament bundles takes place in the yarn path downstream from the preparation device. To that extent the convergence point of the filament bundles can be guided at near the yarn treatment spacing, and thus in the vicinity of the treatment device. With this, a very small height in the melt-spinning device can be realized. The traversing for bridging the center spacing in the spinning device up to the treatment spacing in the treatment device can be achieved essentially solely by traversing the filament bundles. Here, the length of the drop shaft and the cooling shaft can be utilized to maintain a minimum length and the maximum permissible traverse resulting therefrom.

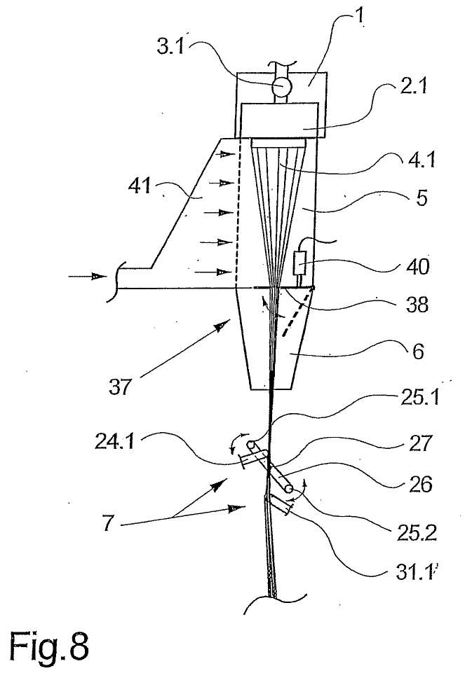

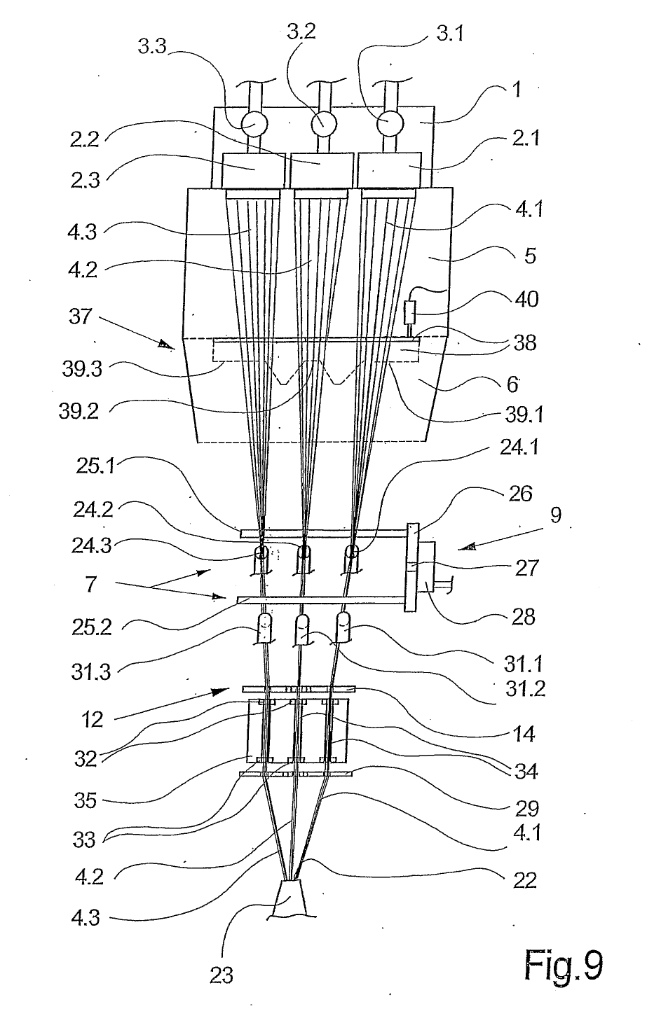

In FIGS. 8 and 9 an additional embodiment of a melt-spinning device according to the invention is represented in two views, which is preferably used in those cases in which a plurality of filament bundles are spun in parallel to one another. The embodiment example is represented in FIG. 8 in a side view and in FIG. 9 in a front view. The design of the embodiment example is identical to the embodiment example according to FIG. 4 so that in the following only the differences will be explained.

In an embodiment of a melt-spinning device according to the invention, specifically the embodiment is represented in FIGS. 8 and 9, an auxiliary separation device 37 is disposed between the cooling shaft 5 and the drop shaft 6. The auxiliary separation device 37 is formed by a profiled plate 38 which comprises several notches 39.1, 39.2, and 39.3. The profiled plate 38 can be pivoted by a pivot actuator 40 from a resting position into an operating position. In FIGS. 8 and 9 the resting position is represented by a dashed line. In the operating position the profiled plate 38 projects into the yarn path and into the filament bundles 4.1 to 4.3. With this, due to the notches 39.1, 39.2, and 39.3, there is a pre-separation of each of the filament bundles 4.1 to 4.3. The combining of the filament strands of the filament bundles 4.1 to 4.3 can be defined here via the configuration of the notches. The subsequent thread-up process downstream from the pre-separation takes place as previously described in the embodiment according to FIG. 4. To that extent reference is made to the preceding description.

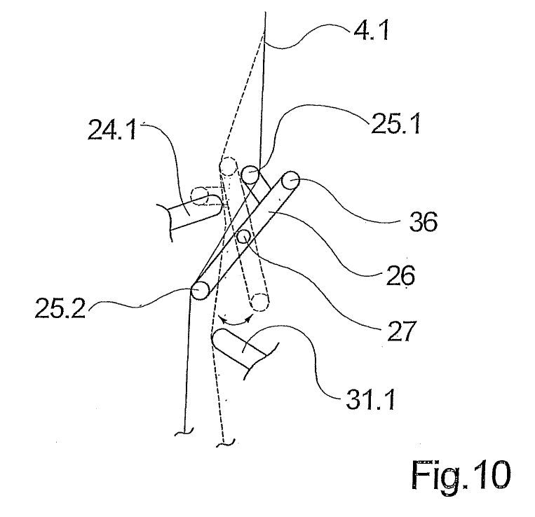

In order to obtain, in the case of the thread-up of the filament bundles represented in FIGS. 4 and 8, an improved spreading of the filament bundles into the preparation device, an additional embodiment for forming an auxiliary guide means is represented in FIG. 10, which, for example, would be usable in the spinning device according to FIG. 4 or FIG. 8. Here, a first diverting rod 25.1 is disposed at a distance from the traversing rod 36. The traversing rod 36 runs parallel to and at a distance from the diverting rod 25.1. The diverting rod 25.1 and the traversing rod 36 are both fastened to the pivot arm 26. The pivot arm 26, which carries the second diverting rod 25.2 on an opposite end, can be pivoted via a central pivot axle 27. Here, the diverting rod 25.1 and the traversing rod 36 are assigned to the upper yarn-oiling member 24.1 and the lower diverting rod 25.2 is assigned to the counter yarn-oiling member 31.1. The diverting rods 25.1 and 25.2 and the traversing rod 36 can be pivoted into a traversing position and an operating position by the pivot arm 26.

In FIG. 10 the traversing position is represented. The operating position is shown as a dashed line. In the traversing position the filament bundle 4.1 is guided by the diverting rods 25.1 and 25.2 without contacting the yarn-oiling member 24.1 and counter yarn-oiling member 31.1. In the operating position the filament bundle is traversed by the traversing rod 36 in the direction of the yarn-oiling member 24.1 so that the filament bundle is held with secure contact of the yarn-oiling member 24.1. The diverting rods 25.1 and 25.2 are disposed in the operating position at a distance from the yarn path so that the filament bundle 4.1 is guided on the lower counter yarn-oiling member 31.1. This configuration of the auxiliary guide means is thus particularly suitable to obtain a forced guiding of the filament bundle in the preparation device.

The spinning device according to the invention as well as the process according to the invention for the thread-up of multifilament yarns was explained with the aid of several exemplary embodiments. Here, the device parts used in any melt-spinning devices and important to the process can be used for the production of multifilament yarns. Thus, the melt-spinning device according to the invention is suitable for producing textile, industrial, or crimped multifilament yarns. As a yarn type FDY, POY, HOY, or BCF monocolor/multicolor can thus be produced. Due to the separation being disposed downstream from the preparation device, the operation for spreading the filament bundles can be carried out from one plane by one operator. By the displacement of the convergence point of the filament bundles towards the treatment device a very small height and compact structure of the spinning device according to the invention is made possible. The formation of the auxiliary guide means and the auxiliary spreading means is also exemplary here. In principle, any yarn-carrying elements can be used which make possible traversing and threading of the filament bundles in a preparation device. Likewise, the number of yarns in the embodiment examples represented is exemplary and not restricted in the spinning device according to the invention.

That which is claimed:

1. A melt-spinning device for spinning a plurality of multifilament yarns comprising:
a plurality of side by side spinnerets for extruding respective filament bundles, with the spinnerets having a predetermined center spacing (M),
a preparation device for separately combining the filament bundles to form individual yarns,
at least one treatment device for treating the yarns with a treatment spacing (B) between the yarns which is significantly less than the center spacing (M), and
an auxiliary spreading means including a plurality of separating yarn guides positioned between the preparation device and the at least one treatment device, wherein the separating yarn guides are disposed to have a yarn spacing (S) which is significantly less than the center spacing (M).

2. The melt-spinning device of claim 1, further comprising an auxiliary guide means positioned adjacent the preparation device, wherein the auxiliary guide means is mounted so as to be movable from a traversing position into an operating position to guide the yarns into the preparation device.

3. The melt-spinning device of claim 2, wherein the auxiliary guide means comprises a guide rod on which the filament bundles are guided so as to be parallel and next to one another during thread-up.

4. The melt-spinning device of claim 2, wherein that the preparation device is disposed in the yarn path upstream from the separating yarn guides in such a manner that the filament bundles can be guided in a straight path between the spinnerets and the separating yarn guides and can be threaded into the preparation device.

5. The melt-spinning device of claim 2, wherein the preparation device comprises several yarn-oiling members assigned to the yarns and wherein the auxiliary guide means is formed by a diverting rod which comprises a sliding edge, extends parallel to the yarn-oiling members, and is held on a pivot arm.

6. The melt-spinning device of claim 5, wherein the preparation device further comprises counter yarn-oiling members disposed in the yarn path downstream from each of the yarn-oiling members, wherein the yarn-oiling members assigned to a yarn are positioned with their yarn contact faces opposite one another and wherein a second diverting rod of the auxiliary guide means is assigned to the counter yarn-oiling means.

7. The melt-spinning device of claim 5, wherein the auxiliary guide means comprises, extending parallel to the diverting rod, a traversing rod through which the yarns are held in the operating position at the yarn-oiling members.

8. The melt-spinning device of claim 1, wherein the separating yarn guides are mounted on a guide plate which has a guide port assigned to each of the separating yarn guides and wherein the guide ports open onto a spreading edge of the guide plate.

9. The melt-spinning device of claim 8, wherein the spacing (A) between the guide ports on the spreading edge is less than the yarn spacing (S) between the separating yarn guides.

10. The melt-spinning device of claim 1, wherein said one treatment device is formed by an entanglement device, and wherein the yarns are guided for threading into the entanglement device by the separating yarn guides.

11. The melt-spinning device of claim 10, wherein a first guide plate with the separating yarn guides is disposed upstream from the entanglement device and a second guide plate with several outlet yarn guides is disposed downstream of the entanglement device, and wherein each of the guide plates comprises several guide ports for guiding in the yarns.

12. The melt-spinning device according to claim 10, wherein the entanglement device comprises a treatment channel for each yarn and wherein the yarn channels in the entanglement device are disposed so as to be offset relative to a spinning plane of the yarns in such a manner that the yarns are guided into a second treatment device disposed downstream in a treatment plane extending at about 90° relative to the spinning plane.

13. The melt-spinning device of claim 1, wherein in the yarn path between the spinnerets and the auxiliary spreading means, an auxiliary separating means is disposed which causes a pre-distribution of the filament bundles during the thread-up operation.

14. The melt-spinning device according to claim 13, wherein the auxiliary separating means is formed by a profiled plate with several notches which is mounted in such a manner that it can be moved between a cooling shaft and a drop shaft which enclose the filament bundles.

15. A process for threading multifilament yarns in a melt-spinning device comprising the steps of:
spinning a filament bundle from each of a plurality of side by side spinnerets which have a predetermined center spacing (M),
guiding the filament bundles by means of a movable suction device from the spinnerets,
separating the filament bundles at a position downstream of the spinnerets to form yarns,
guiding the yarns into a preparation device and at least one treatment device which are disposed sequentially in the yarn path,
wherein the yarns in the treatment device have a significantly smaller treatment spacing (B) than the center spacing (M), and
wherein during the separating step the yarns are caused by a spreading means to have a yarn spacing (S) which is significantly less than the center spacing (M).

16. The process of claim 15, wherein an auxiliary guide means is positioned in an initial traversing position adjacent the preparation device so as to guide the filament bundles to be spaced from the preparation device.

17. The process of claim 16, wherein the filament bundles are guided into operative engagement with the preparation device by moving the auxiliary guide means from the traversing position into an operating position.

18. The process of claim 15, wherein the separating step includes moving the suction device so that the filament bundles are automatically laid into respective separating yarn guides.

19. The process of claim 18, wherein the separating step further includes guiding the filament bundles onto a spreading edge of a guide plate which includes respective guide ports for the individual filament bundles and which are associated with respective separating yarn guides.
